(19) United States
(12) Patent Application Publication
(10) Pub. No.: US 2003/0205065 A1
(43) Pub. Date: Nov. 6, 2003

(54) Method for making hollow glass optical waveguide

(76) Inventors: Yuji Matsuura, Sendai (JP); Mitsunobu Miyagi, Sendai (JP); Takashi Katagiri, Sendai (JP)

Correspondence Address: YUJI MATSURA, ELECTRICAL COMMUNICATIONS DEPT., TOHOKU UNIVERSITY, 05 AOBA, SENDAI, 9808579, JP

(21) Appl. No.: 10/138,825

(22) Filed: May 6, 2002

(51) Int. Cl. C03B 37/022

(52) U.S. Cl. 65/393

(57) ABSTRACT

A method for making optical hollow-glass waveguide. The present invention comprises a glass drawing and following metal coating processes. The waveguide produced by this method provides low transmission loss at target wavelengths in ultraviolet, visible, and infrared regions when the wall thickness of the glass tube is well controlled so as to fit to the designed parameter.

### BACKGROUND OF THE INVENTION

1. Field of the Art

This invention relates to optical waveguides, and more particularly to a flexible hollow waveguide for transmitting ultraviolet, visible, and infrared light.

2. Prior Art

Hollow fibers are promising, flexible delivery media of high-powered infrared lasers used in medical and industrial fields. Some hollow fibers are already employed in laser systems due to the flexibility, ruggedness, high power capability, and low losses. These fibers are usually fabricated by depositing a metal and dielectric films on the inner surface of pre-drawn glass or plastic tubing. See U.S. Pat. No. 5,440,664, issued to Harrington, and U.S. Pat. No. 4,930,863, issued to Croitoru. Therefore, the manufacturing cost tends to be high due to the elaborate processes and the lengths of produced fibers are usually limited to 2-3 m. In these prior methods, dielectric and metal films are coated on the inner surface of tubing by flowing liquid or gaseous precursors. Therefore, it is difficult to make a waveguide with a very small inner diameter which is highly flexible.

Infrared glass-hollow waveguides, such as disclosed in U.S. Pat. No. 4,453,803, issued to Hidaka, and U.S. Pat. No. 5,026,142, issued to Worrel utilize attenuated total reflection of some oxide glasses resulted from the anomalous dispersion of glass materials at a specific wavelength. Since this type of waveguide is drawn from glass preform, a long waveguide with a small inner diameter is easily produced at low cost. However, the wavelength span is limited due to the material properties, although the target wavelength can be shifted by mixing some different glasses. Moreover, material absorption which slightly exists in those glasses lowers the reflective coefficient at the inner wall, and thus, the transmission loss of the fabricated waveguide is usually high even at the target wavelength.

### SUMMARY OF THE INVENTION

The present invention is a method for making a flexible hollow waveguide. By overcoming the above disadvantages of the prior art, the present invention provides inexpensive fabrication of hollow waveguides which show high transmissivity in any target wavelengths in ultraviolet, visible, and infrared regions. A long and highly flexible fiber with a small inner diameter is produced by the present method.

In the present invention, waveguides are drawn from glass-pipe preform, and thus, a long and small-bore fiber is inexpensively produced. A tubing with thin glass wall forms the fiber and the wall thickness is fine-adjusted for utilizing the interference effect to obtain a low transmission loss at a target wavelength. A metal coating can be applied on the glass tube for further loss reduction and to optically shield the transmitted beam from external environment.

In the present invention, to make a hollow waveguide, a glass tube preform is drawn at a high temperature and the wall thickness of the hollow waveguide is controlled so that the reflective coefficient of the inner surface of the waveguide is enhanced by the interference effect of the glass wall at objective wavelengths. The target can be any wavelength in ultraviolet, visible, and infrared regions by designing the wall thickness properly.

To reduce the transmission loss, the waveguide can be coated with a metal layer. This metal cover layer is also effective to shield the transmitted beam from external environment. Furthermore, the metal layer reinforces the waveguide for actual uses.

The glass tube waveguide can be covered with a multiple stack of dielectric films which is designed to provide extremely high reflectance at target wavelengths when stacked on the glass tube with a specific wall thickness. When the number of the dielectric films are not large, it can be covered with a metal film to reduce the transmission loss of the waveguide.

The above and other objects, features and advantages of the present invention will become apparent from the following description when taken in conjunction with the accompanying drawings in which a preferred embodiment of the present invention is shown by way of illustrative examples.

### BRIEF DESCRIPTION OF THE DRAWINGS

FIG. 1 is a cross-sectional view of an embodiment of the hollow waveguide according to the present invention, showing its construction.

FIG. 2 is a graph of theoretical losses of the HE₁₁ mode in the SiO₂ tube waveguide and SiO₂-tube waveguide coated with Ag layer. The inner diameter of the waveguides is 280 μm.

FIG. 3.is a graph of measured losses of the Pyrex-glass tube waveguide and Pyrex-tube waveguide with a silver outer coating.

### DETAIED DESCRIPTION OF THE INVENTION

Preferred embodiments of the present invention will hereinafter be described with reference to the accompanying drawings.

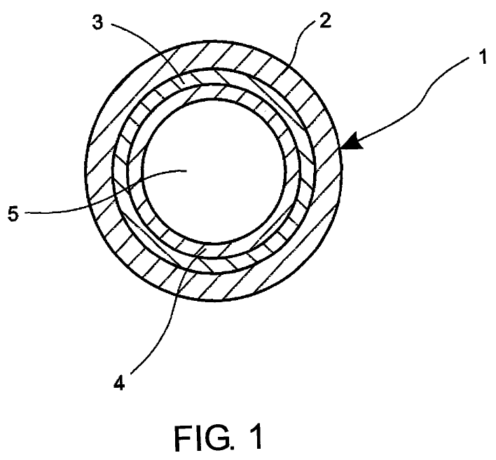

FIG. 1 is a cross sectional view of an embodiment of the hollow waveguide according to the present invention. As shown in the figure, the hollow waveguide 1 is composed of a glass layer 2, a metal layer 3 on the outside of the glass tube, and a protective layer 4.

In the present invention a glass tube is employed as a preform. Absorption coefficient of the glass should be small at the target wavelength region. Silica glass is a preferable material because of the high transparency in ultraviolet, visible, and infrared regions. Some glasses which have lower glass transition temperature, such as Pyrex glasses and sodium glasses, are preferred when low-cost production is important. For mid- to far-infrared regions, some special glasses such as chalcogenides are preferred due to the high transparency at the longer wavelength than 3 μm.

A glass hollow waveguide is drawn from the glass-tube preform by melting the preform at a high temperature. In a usual drawing condition, the ratio of the glass-wall thickness to the tube diameter is preserved when drawn from the tube preform to a small-bore hollow fiber. Therefore, the thickness-to-diameter ratio of the preform should be closed to the designed one. The wall thickness of the drawn hollow fiber can be also controlled by giving a differential pressure between the inside and the outside of the tube preform when drawn.

In the example shown in FIG. 1, a metal layer 3 is added on the outside of the tube to reduce the transmission loss. The metal layer 3 also functions as a shield between the transmitted beam in the hollow core and environment outside. Furthermore, the metal layer 3 reinforces the waveguide when the thickness is sufficiently large. Metals providing high reflection at the target wavelength region are necessary. Aluminum and silver is preferred for ultraviolet and visible region, respectively. For the infrared, silver, gold, molybdenum, and nickel are the preferred materials. As methods for forming the metal layer, plating, vacuum evaporation, sputtering are applicable. A thick metal layer can be formed by passing the tube through a molten alloy. Since the strength of the drawn glass tube is usually degraded soon after the drawing, a setup for the metal coating is preferably located just below the drawing furnace.

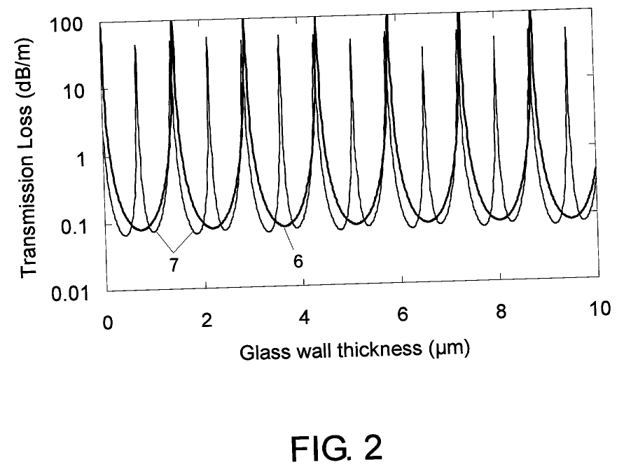

FIG. 2 is a graph of theoretical losses of the HE₁₁ mode in the SiO₂ tube waveguide 6 and SiO₂-tube waveguide with a silver outer coating 7. The inner diameter of the waveguides is 280 μm. The wall thickness d giving the minimum is expressed as,

$$d = \frac{1}{\sqrt{{n}^{2} - 1}} \cdot \frac{λ}{2} ( m + \frac{1}{2} ) \qquad ( m = 0 , 1 , 2 , … )$$

where n is the refractive index of the glass and λ is the target wavelength.

The optimum thickness d for the glass wall of the waveguide with an outer metal coating is expressed as,

$$d = \frac{1}{\sqrt{{n}^{2} - 1}} \cdot \frac{λ}{2} ( m + \frac{1}{π} {tan}^{- 1} \frac{n}{{( {n}^{2} - 1 )}^{1 / 4}} ) \qquad ( m = 0 , 1 , 2 , … )$$

As shown in the figure and the above equations, the optimum thickness appears periodically when increasing the glass wall thickness. Therefore, the thickness can be large enough to support the tube shape although, in prior art, the smallest thickness which give the minimum loss (m=0 in the above equations) was chosen for simplicity of the coating process of the dielectric. The glass wall thickness which is too small results lack of mechanical strength. On the other hand, when the thickness is too large, absorption which slightly exists in the glass material increases transmission loss of the waveguide. Preferred wall thickness is in the ragnge of 5 to 20 μm and it should satisfy the conditions shown in the above equations. For the production of the waveguides, tolerated deviation from the optimum condition is around 10%.

The thickness of the metal layer 3 is preferably thicker than 100 nm since the shielding effect becomes insufficient when the thickness is too small. To provide sufficient mechanical strength to the waveguide, the metal thickness is preferably larger than 10 μm. The thickness is, however, preferably smaller than 200 μm to give flexibility to the waveguide.

To provide mechanical strength to the waveguide, a protective layer 4 may be applied on the glass tube with a thin metal coating 3. As the material of the protective layer 4, metals and resins are preferred.

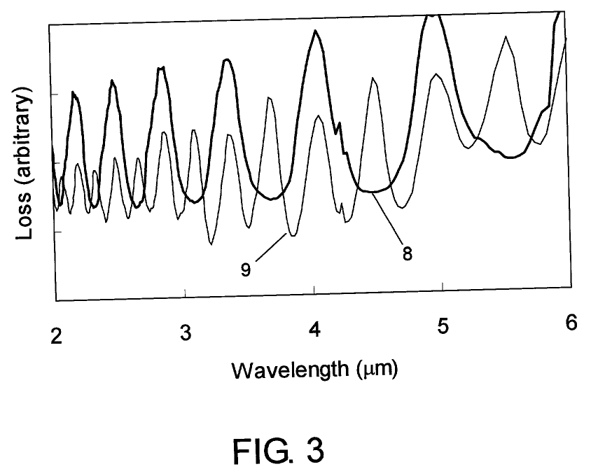

FIG. 3 shows measured losses of the Pyrex-glass tube waveguide 8 and Pyrex-tube waveguide with a silver outer coating 9. These fibers are drawn from a Pyrex-glass-tube preform with a diameter of 50 mm and a wall thickness of 1.6 mm at the temperature of 900° C. The inner diameter of the fiber is 280 μm and the glass wall thickness is 9.9 μm which is optimized for the target wavelength of 2.94-μm of Er:YAG laser light using the above equations. To form the silver layer of the waveguide 9, a conventional, silver-plating method is applied right after the glass drawing. Loss oscillation due to the interference effect of the thin glass wall is seen in the measured spectra as predicted from the theory which is shown in FIG. 2. The effect of the silver coating for loss reduction is also shown in FIG. 3.

A multilayer dielectric coating may be applied on the glass tube to reduce the transmission loss or to give a dispersion function to the waveguide. When the number of dielectric layers is small, an additional metal layer may be applied on the outside of the multilayer to reduce the transmission loss of the waveguide.

The invention may be embodied in other specific forms without departing from the spirit or essential characteristics thereof The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

We claim:

1. A method of making a hollow waveguide, comprising:
employing a glass tube as a preform;
drawing a hollow waveguide from the preform by melting the preform at a high temperature;
controlling the wall thickness of the hollow waveguide to enhance the reflective coefficient of the inner surface of the waveguide at objective wavelengths utilizing the interference effect of the glass wall.

2. The method according to claim 1, wherein said hollow waveguide is covered with a metal layer.

3. The method according to claim 1, wherein said hollow waveguide is covered with a multiple stack of dielectric films.

4. The method according to claim 3, where in said multiple stack of dielectric films are covered with a metal layer.
